(19) United States
(12) Patent Application Publication
(10) Pub. No.: US 2007/0126995 A1
(43) Pub. Date: Jun. 7, 2007

(54) LIGHT GENERATOR OF A PROJECTOR

(76) Inventor: Chao-Han Pao, Miao- Li Hsien (TW)

Correspondence Address: NORTH AMERICA INTELLECTUAL PROPERTY CORPORATION, P.O. BOX 506, MERRIFIELD, VA, 22116, US

(21) Appl. No.: 11/567,177

(22) Filed: Dec. 5, 2006

(30) Foreign Application Priority Data
Dec. 6, 2005 (TW) 094142963

(51) Int. Cl. G03B 21/14

(52) U.S. Cl. 353/97

(57) ABSTRACT

A structure of a light source for a projector includes a light source, a housing and a shade. The housing includes a transparent surface. The light source is disposed in the housing. The shade is disposed on the transparent surface for blocking part of light emitted from the light source.

### BACKGROUND OF THE INVENTION

1. Field of the Invention

The present invention relates to a light generator of a projector, and more particularly, to a light generator of a projector capable of reducing light leakage.

2. Description of the Prior Art

Projectors are conventionally used in conference briefings in which the host projects data or graphics on a screen for familiarizing attendants with the current presentation. With the rapid development of technology, projectors have been widely used in other applications. With high power hi-fi equipment, large-sized digital video discs (DVDs) and the super-large images generated by a projector, it is now possible to reconstruct visual and acoustic effects similar to those provided in a movie theater at home.

Digital projectors are devices that optically project images onto large-sized screens. Common digital projectors include cathode ray tube (CRT) projectors, liquid crystal display (LCD) projectors, digital light processing (DLP) projectors, and liquid crystal on silicon (LCOS) projectors. The light strength of a digital projector is a major concern, regardless of which projecting technology is used. In general, stronger light strength results in higher projecting brightness and better projecting quality.

FIG. 1 shows a light generator 10 of a prior art projector. The light generator 10 includes a light source 12 and a housing 14 having a transparent surface 16. The light emitted by the light source 12 is normally processed by an optical processing system 18 for forming images on a screen 36. The optical processing system 18 can include optical devices such as apertures, lenses, filters, gratings, object lenses or image-capturing devices. For simplicity, a device having an aperture 23 in FIG. 1 is used for representing the optical processing system 18.

The operating principle of a DLP projector is similar to that of a slide projector, in which a light bulb of high brightness is used for the light source 12. The DLP projector includes many optical devices, such as in the optical processing system 18, for forming images on the screen 36. While each optical device in the optical processing system 18 influences the image quality, the light bulb used for the light source 12 is the dominant factor of the overall display quality. If a light bulb has poor luminance or uniformity, the gray scales of images formed on the screen 36 may deviate from the nominal values, and light leakage may occur as well.

In FIG. 1, a region between the light source 12 and the aperture 23 is referred to “near field”, while a region between the aperture 23 and the screen 36 is referred to “far field”. Different light bulbs have different far field distributions. In the prior art light generator 10, once the light source 12 is replaced with a new light bulb, different far field distribution of the DLP projector between the light bulbs can cause light leakage in the far field distribution of the DLP projector.

### SUMMARY OF THE INVENTION

The present invention provides a light generator of a projector comprising a housing having a transparent surface; a light source disposed in the housing; and a shade disposed on the transparent surface for preventing light leakage of the light source.

These and other objectives of the present invention will no doubt become obvious to those of ordinary skill in the art after reading the following detailed description of the preferred embodiment that is illustrated in the various figures and drawings.

### BRIEF DESCRIPTION OF THE DRAWINGS

FIG. 1 shows a light generator of a prior art projector.

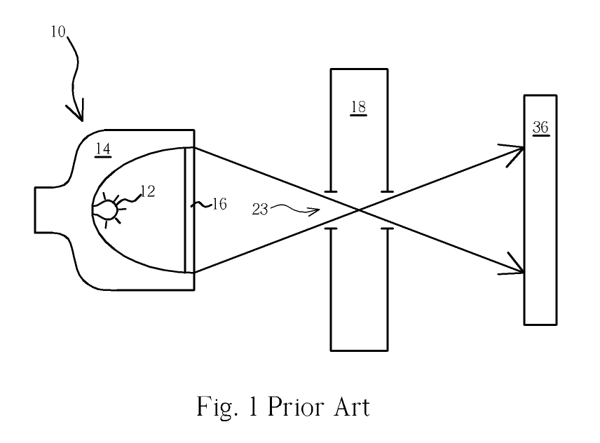

FIG. 2 shows a light generator of a projector according to the present invention.

FIG. 3 shows a far field distribution of a projector on a screen.

FIG. 4 shows a front view of the light generator according to a first embodiment of the present invention.

FIG. 5 shows a front view of the light generator according to a second embodiment of the present invention.

FIG. 6 shows a front view of the light generator according to a third embodiment of the present invention.

### DETAILED DESCRIPTION

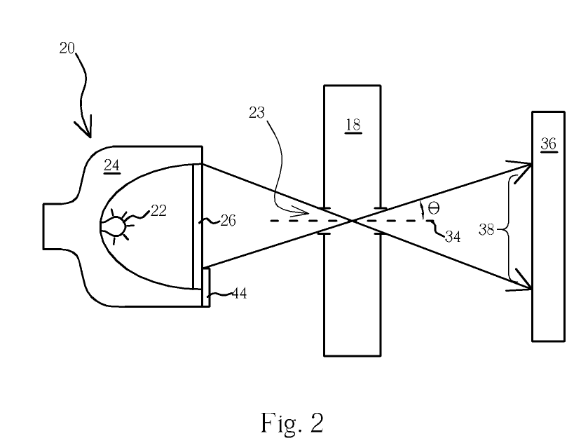

The present invention provides a light generator for a projector capable of reducing light leakage in the far field distribution. FIG. 2 shows a light generator 20 of a projector according to the present invention. The light generator 20 includes a light source 22, a housing 24, and a shade 44. The light emitted by the light source 22 is normally processed by an optical processing system 18 for forming images on a screen 36. The optical processing system 18 can include optical devices such as apertures, lenses, filters, gratings, object lenses or image-capturing devices. For simplicity, a device having an aperture 23 in FIG. 2 is used for representing the optical processing system 18. The housing 24 includes a transparent surface 26, which can include a plane, a concave surface, or a convex surface. The light source 22 is disposed in the housing 24, and the shade 44 is disposed on the transparent surface 26 for preventing light leakage of the light generator 20 in the far field distribution. After being processed by the optical processing system 18, the light emitted by the light source 22 is projected onto the screen 36 at an angle θ with respect to a normal 34 of the optical processing system 18. As shown in FIG. 2, the light generator 20 can be used in a DLP projector.

The light generator 20 of the present invention differs from the prior art light generator 10 in that the light generator 20 includes the shade 44, which will be described in more detail. The shade 44 can prevent the light leakage of the light generator 20 outside a far field effective region 38, which is controlled by the optical processing system 18. By using different optical devices in the optical processing system 18, the ranges of the far field effective region 38 can be adjusted. The far field effective region 38 can be defined by a parameter F/# of the projector and be represented by the following formula:
F/#=1/(2*sin θ)

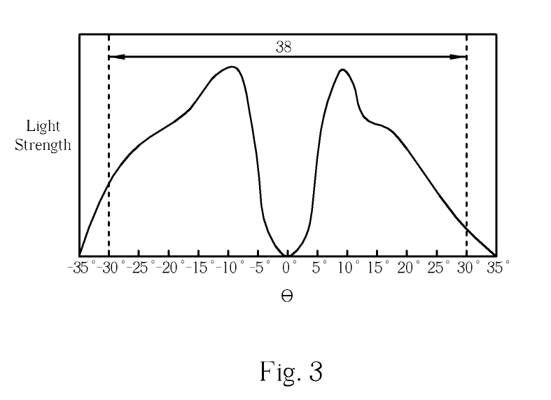

FIG. 3 shows a far field distribution of a projector on a screen. The transverse axle represents the value of θ, and θ=0 represents a region on the screen 36 onto which light emitted by the light source 22 is projected along the normal 34 of the optical processing system 18. The vertical axle represent light strength received on the screen 36 at a certain θ. Generally, the lamp F/# of a projector equals to 1, which means θ=30° and the far field effective region 38 is between −30 °<θ<30°. Therefore, the light received on the screen 36 in the regions having θ<−30° and θ>30° is the light leakage of the projector in the far field distribution.

A projector has three operating states: an “on” state, an “off” state, and a “flat” state. The optical processing system 18 includes a grating comprising arrays formed by tiltable pixel mirrors. In the “on” state, the tiltable pixel mirrors reflect incident light generated by the light source 22 onto the screen 36. In the “off” state, the tiltable pixel mirrors reflect incident light generated by the light source 22 off the screen 36. In the “flat” state, the tiltable pixel mirrors are disposed in a parallel direction with the incident light.

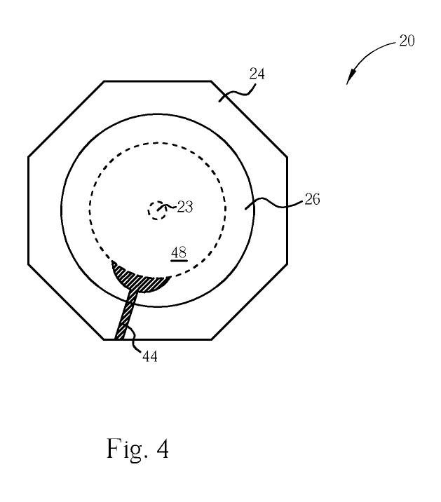

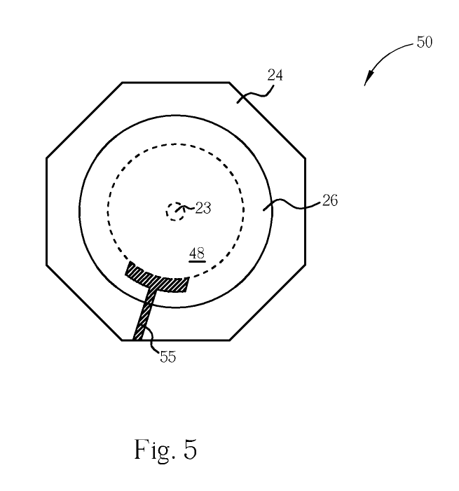

In the present invention, the shade 44 is disposed based on the light leakage of the light source in the far field distribution when a projector operates in the “flat” state. FIG. 4 shows a front view of the housing 24 in the light generator 20 according to a first embodiment of the present invention. The housing 24 includes a transparent surface 26, which can be a plane, a concave surface, or a convex surface. Based on a predetermined far field effective region 38, such as θ=30°, a region 48 (FIG. 5) represents a corresponding effective region on the light generator 20. Ideally, the light emitted by the light source 22 only passes through the region 48, and no light leakage occurs in far field images projected on the screen 36. However in reality, the far field light leakage in the flat state often takes place due to variations of light source quality. In the first embodiment shown in FIG. 4, the shade 44 has a half-moon shape and is made of light-blocking material. The shade 44 is disposed on the transparent surface 26 outside the region 48, and the region where the shade 44 is disposed corresponds to the far field light leakage of the light source 22.

Although different types of light sources result in different far field light leakage, the far field light leakage of a projector usually has slight leakage near the far field effective region 38. The major difference caused by different types of light sources is the location around the far field effective region 38 where the leakage takes place. The shade 44 in the first embodiment has a half-moon shape, which can easily be disposed on different locations on the transparent surface 26. Based on different far field light leakage caused by different types of light sources, the shade 44 can be disposed on corresponding locations of the transparent surface 26 for reducing the far field light leakage of the projector.

FIG. 5 shows a front view of another light generator 50 according to a second embodiment of the present invention. The light generator 50 includes the housing 24 and a shade 55. The housing 24 includes a transparent surface 26, which can include a plane, a concave surface, or a convex surface. Based on a predetermined far field effective region 38, such as θ=30°, a region 48 represents a corresponding effective region of the light generator 50. In the second embodiment shown in FIG. 5, the shade 55 has a band shape and is made of light-blocking material. The shade 55 is disposed on the transparent surface 26 surrounding the region 48, and the region where the shade 55 is disposed corresponds to the far field light leakage of the light source 22. Therefore, the shade 55 can reduce different far field light leakage caused by different types of light sources.

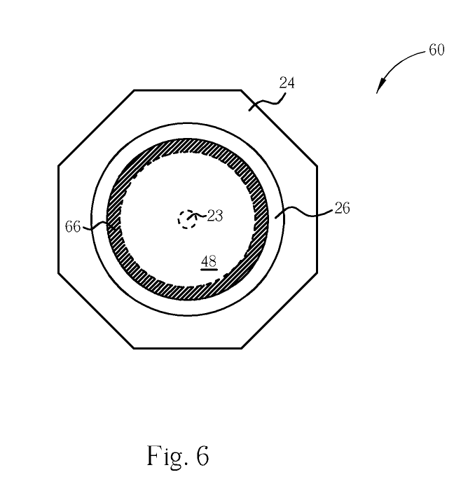

FIG. 6 shows a front view of another light generator 60 according to a third embodiment of the present invention. The light generator 60 includes the housing 24 and a shade 66. The housing 24 includes a transparent surface 26, which can include a plane, a concave surface, or a convex surface. Based on a predetermined far field effective region 38, such as θ=30°, a region 48 represents a corresponding effective region on the light generator 60. In the second embodiment shown in FIG. 5, the shade 66 has a ring shape and is made of light-blocking material. The shade 66 is disposed on the transparent surface 26 surrounding the region 48, and the region where the shade 66 is disposed corresponds to the far field light leakage of the light source 22. Therefore, the shade 66 can reduce different far field light leakage caused by different types of light sources.

In the embodiments shown in FIG. 4-6, the shades 44, 55, and 66 are made of light-blocking material and have a half-moon shape, a band shape, and a ring shape, respectively. However, the present invention can also use shades of other shapes for preventing the far field light leakage. Also, the embodiments shown in FIG. 4-6 each includes a shade. However, if the far field light leakage is severe, the present invention can also include a plurality of shades, which can have the same or different shapes, for reducing the far field light leakage more effectively.

In the light generator of the projector in the present invention, a shade is used for reducing the far field light leakage and can be disposed in different ways. For example, a notch for assembling the shade can be formed at a proper location of the transparent surface, so that the shade can be attached to the transparent surface of the light generator. Or, each of the shade can include a corresponding hole, so that the shade can be attached to the transparent surface of the light generator by displacing screws or other connecting devices in the holes.

In the present invention, a shade of various shapes can be disposed flexibly on the transparent surface 26 of the light generator based on different far field light leakage caused by different types of light sources. In addition, a plurality of shades, which can have the same or different shapes, can be disposed flexibly on the transparent surface 26 of the light generator for reducing the far field light leakage more effectively.

Those skilled in the art will readily observe that numerous modifications and alterations of the device and method may be made while retaining the teachings of the invention. Accordingly, the above disclosure should be construed as limited only by the metes and bounds of the appended claims.

What is claimed is:

1. A light generator of a projector comprising:
a housing having a transparent surface;
a light source disposed in the housing; and
a shade disposed on the transparent surface for preventing light leakage of the light source.

2. The light generator of claim 1 wherein the transparent surface of the housing includes a transparent plane, a transparent concave surface, or a transparent convex surface.

3. The light generator of claim 1 wherein the shade is made of light-blocking material.

4. The light generator of claim 3 wherein the shade has a half-moon shape.

5. The light generator of claim 3 wherein the shade has a band shape.

6. The light generator of claim 3 wherein the shade has a ring shape.

7. The light generator of claim 1 wherein the light generator provides light for a digital light processing (DLP) projector.

8. The light generator of claim 1 wherein the housing further includes a notch, and the shade is disposed on the transparent surface via the notch.

9. The light generator of claim 1 wherein the housing and the shade each further includes a hole, and the light generator further includes a connecting device disposed in the holes of the housing and the shade for attaching the shade to the housing.

10. The light generator of claim 9 wherein the connecting device includes a screw.
